(19) United States
(12) Patent Application Publication
(10) Pub. No.: US 2022/0116509 A1
(43) Pub. Date: Apr. 14, 2022

(54) IMAGE READING APPARATUS FOR DETECTING END PORTION OF FRONT END OR REAR END OF MEDIUM

(71) Applicant: PFU LIMITED, Kahoku-shi (JP)

(72) Inventor: Masaaki Sakai, Kahoku-shi (JP)

(21) Appl. No.: 17/473,811

(22) Filed: Sep. 13, 2021

(30) Foreign Application Priority Data
Oct. 12, 2020 (JP) 2020-172088

(51) Int. Cl. H04N 1/047; H04N 1/12; H04N 1/00

(52) U.S. Cl. CPC H04N 1/0473; H04N 2201/0081; H04N 1/00013; H04N 1/1215

(57) ABSTRACT

An image reading apparatus includes an imaging device to image a medium, and a processor to detect a plurality of edge pixels in a sub-scanning direction based on gradation values of a plurality of pixels of which positions in a main scanning direction are mutually the same and a distance between pixels in the sub-scanning direction is within a predetermined range in an input image acquired by imaging the medium by the imaging device, detect an end portion in the main scanning direction of a front end or a rear end of the medium based on a positional relationship between the detected plurality of edge pixels in the sub-scanning direction, and output information relating to the detected end portion.

### CROSS-REFERENCE TO RELATED APPLICATIONS

This application is based upon and claims the benefit of priority of prior Japanese Patent Application No. 2020-172088, filed on Oct. 12, 2020, the entire contents of which are incorporated herein by reference.

### TECHNICAL FIELD

Embodiments discussed in the present specification relate to image processing.

### BACKGROUND

Generally, an image reading apparatus such as a scanner that reads an image of a medium such as a document has a function of specifying an area including the medium in the read image in order to cut out the area including the medium from the read image. For that purpose, the image reading apparatus is required to detect an end portion of the medium with high accuracy.

An image reading apparatus to acquire an edge portion from digital image data is disclosed (see Japanese Unexamined Patent Application Publication (Kokai) No. 2017-92561). The image reading apparatus detects a pixel whose color changes from a background color as an edge portion in the digital image data, sets a pixel detected as an edge portion to “1”, and sets a pixel not detected as an edge portion to “0”. The image reading apparatus performs a logical sum operation in a sub-scanning direction for each position in a main scanning direction, and calculates, for each pixel in the main scanning direction, a calculation result in which a pixel in which an edge image is detected at least once is set as “1” and a pixel in which an edge is not detected at all is set as “0”, as an edge information. The image reading apparatus confirms the edge information for each pixel from both directions in the main scanning direction in order, and determines the first pixel is the edge portion when a predetermined number of pixels whose value is set to “1” are consecutive in the edge information.

An image reading apparatus to estimate a size of a document based on edges of the document detected on two detected lines located on both sides of a reference line corresponding to a center line in a width direction of a document feed path, in a scanned image data, is disclosed (see Japanese Unexamined Patent Application Publication (Kokai) No. 2011-35530).

An image reading apparatus to acquire a boundary coordinate value between a background portion and a portion of a document image in a read image is disclosed (see Japanese Unexamined Patent Application Publication (Kokai) No. 2008-124828). The image reading apparatus scans the read image in the sub-scanning direction to acquire differential information relating to the sub-scanning direction of the read image, and acquire binarized information in which the differential information value is set to 1 when the differential information value exceeds a threshold value, and otherwise, the differential information value is set to 0. The image reading apparatus acquires an x-coordinate value of a pixel having the smallest x-coordinate value and an x-coordinate value of a pixel having the largest x-coordinate value among pixels in which the binarization information is 1 in each horizontal line, as a boundary coordinate value between the background portion and the portion of the document image.

### SUMMARY

According to some embodiments, an image reading apparatus includes an imaging device to image a medium, and a processor to detect a plurality of edge pixels in a sub-scanning direction based on gradation values of a plurality of pixels of which positions in a main scanning direction are mutually the same and a distance between pixels in the sub-scanning direction is within a predetermined range in an input image acquired by imaging the medium by the imaging device, detect an end portion in the main scanning direction of a front end or a rear end of the medium based on a positional relationship between the detected plurality of edge pixels in the sub-scanning direction, and output information relating to the detected end portion.

According to some embodiments, an image processing method includes imaging a medium by an imaging device, detecting a plurality of edge pixels in a sub-scanning direction based on gradation values of a plurality of pixels of which positions in a main scanning direction are mutually the same and a distance between pixels in the sub-scanning direction is within a predetermined range in an input image acquired by imaging the medium by the imaging device, detecting an end portion in the main scanning direction of a front end or a rear end of the medium based on a positional relationship between the detected plurality of edge pixels in the sub-scanning direction, and outputting information relating to the detected end portion.

According to some embodiments, a computer-readable, non-transitory medium stores a computer program. The computer program causes an image reading apparatus including an imaging device to image a medium, to execute a process including detecting a plurality of edge pixels in a sub-scanning direction based on gradation values of a plurality of pixels of which positions in a main scanning direction are mutually the same and a distance between pixels in the sub-scanning direction is within a predetermined range in an input image acquired by imaging the medium by the imaging device, detecting an end portion in the main scanning direction of a front end or a rear end of the medium based on a positional relationship between the detected plurality of edge pixels in the sub-scanning direction, and outputting information relating to the detected end portion.

### BRIEF DESCRIPTION OF DRAWINGS

FIG. 1 is a perspective view illustrating an image reading apparatus 100 according to an embodiment.

FIG. 2 is a diagram for illustrating a conveyance path inside the image reading apparatus 100.

FIG. 3 is a block diagram illustrating a schematic configuration of the image reading apparatus 100.

FIG. 4 is a diagram illustrating schematic configurations of a storage device 140 and a processing circuit 150.

FIG. 5 is a flowchart illustrating an operation example of a medium reading processing.

FIG. 6 is a flowchart illustrating an operation example of the medium reading processing.

FIG. 7 is a schematic diagram illustrating an example of an input image 700.

FIG. 8 is a schematic diagram for illustrating an upper end edge pixel.

FIG. 9 is a schematic diagram for illustrating a histogram 900.

FIG. 10 is a schematic diagram for illustrating grouping.

FIG. 11A is a perspective view illustrating another image reading apparatus 200.

FIG. 11B is a perspective view illustrating the other image reading apparatus 200.

FIG. 12 is a cross-sectional view of the image reading apparatus 200.

FIG. 13 is a diagram illustrating a schematic configuration of a processing circuit 350 in another image reading apparatus.

### DESCRIPTION OF EMBODIMENTS

It is to be understood that both the foregoing general description and the following detailed description are exemplary and explanatory, and are not restrictive of the invention, as claimed.

Hereinafter, an image reading apparatus, an image processing method and a computer-readable, non-transitory medium storing a computer program according to an embodiment, will be described with reference to the drawings. However, it should be noted that the technical scope of the invention is not limited to these embodiments, and extends to the inventions described in the claims and their equivalents.

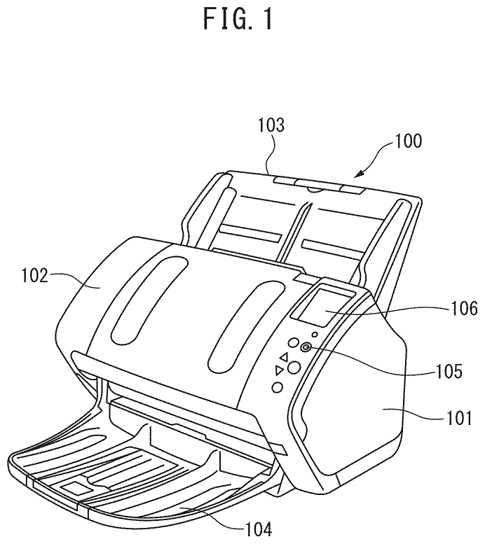

FIG. 1 is a perspective view illustrating an image reading apparatus 100 configured as an image scanner. The image reading apparatus 100 conveys and images a medium that is a document. A medium is a paper, a thick paper, a card, a brochure, a passport, etc. For example, a card is a plastic resin card. Particularly, a card is an identification (ID) card defined by International Organization for Standardization (ISO)/International Electrotechnical Commission (IEC) 7810. A card may be another type of card. The image reading apparatus 100 may be a facsimile, a copying machine, a printer multifunction machine (MFP, Multifunction Peripheral), etc.

The image reading apparatus 100 includes a lower housing 101, an upper housing 102, a medium tray 103, an ejection tray 104, an operation device 105, and a display device 106, etc.

The upper housing 102 is located at a position covering an upper surface of the image reading apparatus 100 and is engaged with the lower housing 101. The medium tray 103 is engaged with the lower housing 101 in such a way as to be able to place a medium to be conveyed. The ejection tray 104 is engaged with the lower housing 101 in such a way as to be able to hold an ejected medium.

The operation device 105 includes an input device such as a button, and an interface circuit acquiring a signal from the input device, receives an input operation by a user, and outputs an operation signal based on the input operation by the user. The display device 106 includes a display including a liquid crystal or organic electro-luminescence (EL), and an interface circuit for outputting image data to the display, and displays the image data on the display.

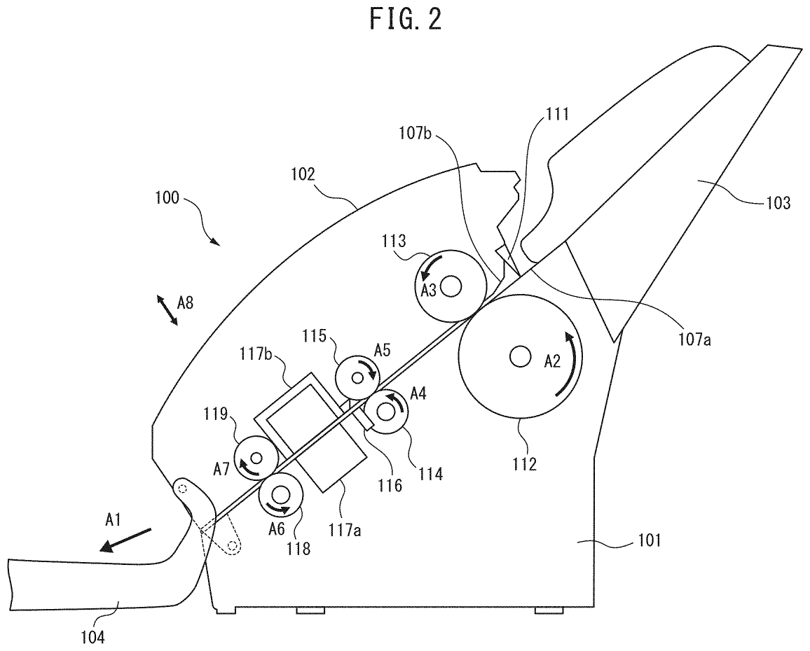

FIG. 2 is a diagram for illustrating a conveyance path inside the image reading apparatus 100.

The conveyance path inside the image reading apparatus 100 includes a first medium sensor 111, a feed roller 112, a brake roller 113, a first conveying roller 114, a second conveying roller 115, a second medium sensor 116, a first imaging device 117a, a second imaging device 117b, a third conveying roller 118 and a fourth conveying roller 119, etc. The numbers of each roller is not limited to one, and may be plural. The first imaging device 117a and the second imaging device 117b may be collectively referred to as imaging devices 117.

A top surface of the lower housing 101 forms a lower guide 107a of a conveyance path of a medium, and a bottom surface of the upper housing 102 forms an upper guide 107b of the conveyance path of a medium. An arrow A1 in FIG. 2 indicates a medium conveying direction. An upstream hereinafter refers to an upstream in the medium conveying direction A1, and a downstream refers to a downstream in the medium conveying direction A1.

The first medium sensor 111 is located on an upstream side of the feed roller 112 and the brake roller 113. The first medium sensor 111 includes a contact detection sensor and detects whether or not a medium is placed on the medium tray 103. The first medium sensor 111 generates and outputs a medium detection signal changing the signal value between a state in which a medium is placed on the medium tray 103 and a state in which a medium is not placed.

The feed roller 112 and the brake roller 113 is provided on an upstream side of the first conveying roller 114 and the second conveying roller 115. The feed rollers 112 are provided on the lower housing 101 and sequentially feed media placed on the medium tray 103 from the lower side. The brake roller 113 is provided in the upper housing 102 and is located to face the feed roller 112.

The first conveying roller 114 and the second conveying roller 115 are provided on a downstream side of the feed roller 112 and the brake roller 113. The first conveyance roller 114 is provided on the lower housing 101. The second conveyance roller 115 is provided in the upper housing 102, and is located to face the first conveyance roller 114. The feed roller 112, the brake roller 113, the first conveying roller 114 and the second conveying roller 115 are an example of a conveyance roller, and conveys the medium to the imaging device 117.

The second medium sensor 116 is located a downstream side of the first conveying roller 114 and the second conveying roller 115 and on an upstream side of and the imaging device 117. The second medium sensor 116 detects whether or not the medium exists at the second medium sensor 115. The second medium sensor 116 includes a light emitter and a light receiver provided on one side with respect to the conveyance path of the medium, and a reflection member such as a mirror provided at a position facing the light emitter and the light receiver across the conveyance path. The light emitter emits light toward the conveyance path. On the other hand, the light receiver receives light projected by the light emitter and reflected by the reflection member, and generates and outputs a second medium signal being an electric signal based on intensity of the received light. Since the light emitted by the light emitter is shielded by the medium when the medium exists at the position of the second medium sensor 116, a signal value of the second medium signal is changed in a state in which the medium exists at the position of the second medium sensor 116 and a stated in which a medium does not exist at the position. The light emitter and the light receiver may be provided at positions facing one another with the conveyance path in between, and the reflection member may be omitted.

The first imaging device 117a includes a line sensor based on a unity-magnification optical system type contact image sensor (CIS) including an imaging element based on a complementary metal oxide semiconductor (CMOS) linearly located in a main scanning direction. Further, the first imaging device 117a includes a lens for forming an image on the imaging element, and an analog-digital (A/D) converter for amplifying and analog-digital (A/D) converting an electric signal output from the imaging element. The first imaging device 117a sequentially generates and outputs line images acquired by imaging an area of a front surface of the medium conveyed by the conveyance roller facing the line sensor at certain intervals. Specifically, a pixel count of a line image in a vertical direction (sub-scanning direction) is 1, and a pixel count in a horizontal direction (main scanning direction) is larger than 1.

The second imaging device 117b is located above the first imaging device 117a so as to face the first imaging device 117a. The second imaging device 117b includes a line sensor based on a unity-magnification optical system type CIS including an imaging element based on a CMOS linearly located in a main scanning direction. Further, the second imaging device 117b includes a lens for forming an image on the imaging element, and an A/D converter for amplifying and A/D converting an electric signal output from the imaging element. The second imaging device 117b sequentially generates and outputs line images acquired by imaging an area of a back surface of the medium conveyed by the conveyance roller facing the line sensor at certain intervals.

The first imaging device 117a and the second imaging device 117b are examples of an imaging device. Only either of the first imaging device 117a and the second imaging device 117b may be located in the image reading apparatus 100 and only one side of a medium may be read. Further, a line sensor based on a unity-magnification optical system type CIS including an imaging element based on charge coupled devices (CCDs) may be used in place of the line sensor based on a unity-magnification optical system type CIS including an imaging element based on a CMOS. Further, a line sensor based on a reduction optical system type line sensor including an imaging element based on CMOS or CCDs.

The third conveying roller 118 and the fourth conveying roller 119 are provided on a downstream side of the imaging device 117. The third conveyance roller 118 is provided on the lower housing 101. The fourth conveyance roller 119 is provided in the upper housing 102, and is located to face the third conveyance roller 118.

A medium placed on the medium tray 103 is conveyed between the lower guide 107a and the upper guide 107b in the medium conveying direction A1 by the feed rollers 112 rotating in a direction of an arrow A2 in FIG. 2. When a medium is conveyed, the brake roller 113 rotate in a direction of an arrow A3. By the workings of the feed roller 112 and the brake roller 113, when a plurality of media are placed on the medium tray 103, only a medium in contact with the feed roller 112, out of the media placed on the medium tray 103, is separated. Consequently, the medium conveying apparatus 100 operates in such a way that conveyance of a medium other than the separated medium is restricted (prevention of multi-feed).

The medium is fed between the first conveyance roller 114 and the second conveyance roller 115 while being guided by the lower guide 107a and the upper guide 107b. The medium is fed between the first imaging device 114a and the second imaging device 114b by the first conveyance roller 114 and the second conveyance roller 115 rotating in directions of an arrow A4 and an arrow A5, respectively. The medium read by the imaging device 117 is ejected on the ejection tray 104 by rotating the third conveyance roller 118 and the fourth conveyance roller 119 in directions of arrows A6 and A7, respectively.

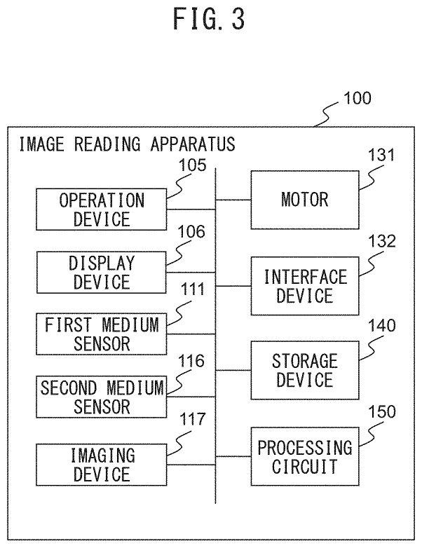

FIG. 3 is a block diagram illustrating a schematic configuration of the image reading apparatus 100.

The image reading apparatus 100 further includes a motor 131, an interface device 132, a storage device 140, and a processing circuit 150, etc., in addition to the configuration described above.

The motor 131 includes one or a plurality of motors, and conveys a medium by rotating the feed roller 112, the brake roller 113, the first conveying roller 114, the second conveying roller 115, the third conveying roller 118 and the fourth conveyance roller 119, by a control signal from the processing circuit 150.

For example, the interface device 132 includes an interface circuit conforming to a serial bus such as universal serial bus (USB), is electrically connected to an unillustrated information processing device (for example, a personal computer or a mobile information terminal), and transmits and receives an input image and various types of information. Further, a communication device including an antenna transmitting and receiving wireless signals, and a wireless communication interface device for transmitting and receiving signals through a wireless communication line in conformance with a predetermined communication protocol may be used in place of the interface device 132. For example, the predetermined communication protocol is a wireless local area network (LAN).

The storage device 140 includes a memory device such as a random access memory (RAM) or a read only memory (ROM), a fixed disk device such as a hard disk, or a portable storage device such as a flexible disk or an optical disk. The storage device 140 stores computer programs, databases, tables, etc., used for various kinds of processing of the image processing apparatus 100. The computer program may be installed on the storage device 140 from a computer-readable, non-transitory medium such as a compact disc read only memory (CD-ROM), a digital versatile disc read only memory (DVD-ROM), etc., by using a well-known setup program, etc.

The processing circuit 150 operates in accordance with a program previously stored in the storage device 140. Instead of the processing circuit 150, a digital signal processor (DSP), a large scale integration (LSI), an application specific integrated circuit (ASIC), a field-programmable gate array (FPGA), etc., may be used.

The processing circuit 150 is connected to the operation device 105, the display device 106, the first medium sensor 111, the second medium sensor 116, the imaging device 117, the motor 131, the interface device 132 and the storage device 140, etc., and controls each of these units. The processing circuit 150 performs the drive control of the motor 131, imaging control of the imaging device 117, etc., acquires an image, and transmits it to the information processing apparatus (not shown) through the interface device 132. Further, the processing circuit 150 detects an end portion of the medium based on the image imaged by the imaging device 117.

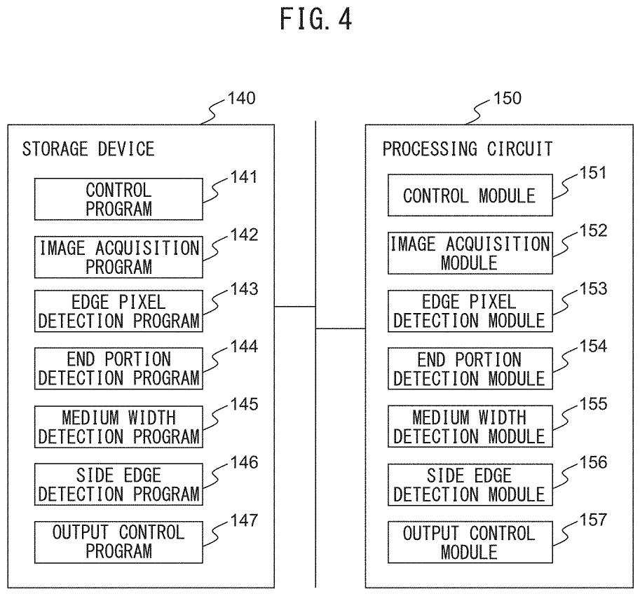

FIG. 4 is a diagram illustrating schematic configurations of a storage device 140 and a processing circuit 150.

As illustrated in FIG. 4, the storage device 140 stores a control program 141, an image acquisition program 142, an edge pixel detection program 143, an end portion detection program 144, a medium width detection program 145, a side edge detection program 146 and an output control program 147, etc. Each of these programs is a functional module implemented by software operating on a processor. The processing circuit 150 reads each program stored in the storage device 140 and operates in accordance with each read program. Thus, the processing circuit 150 functions as a control module 151, an image acquisition module 152, an edge pixel detection module 153, an end portion detection module 154, a medium width detection module 155, a side edge detection module 156 and an output control module 157.

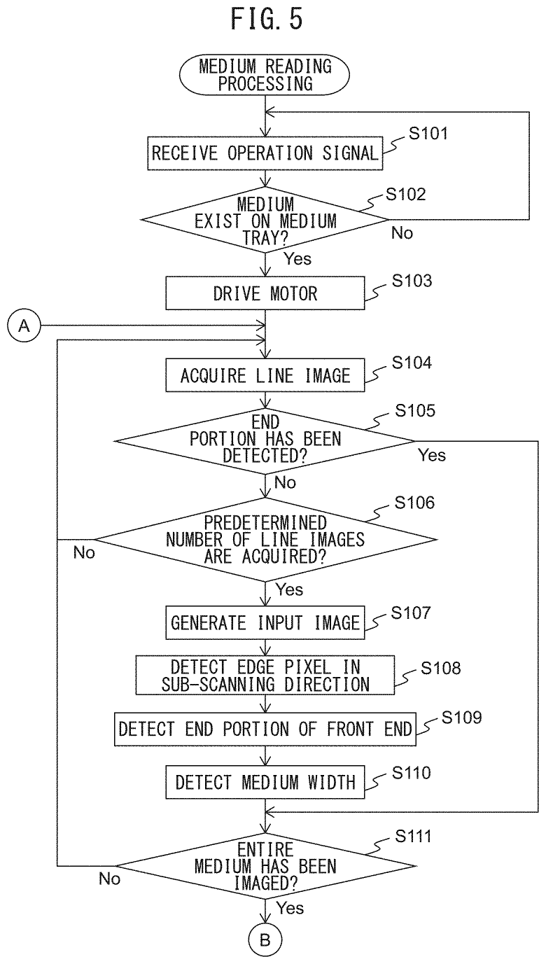

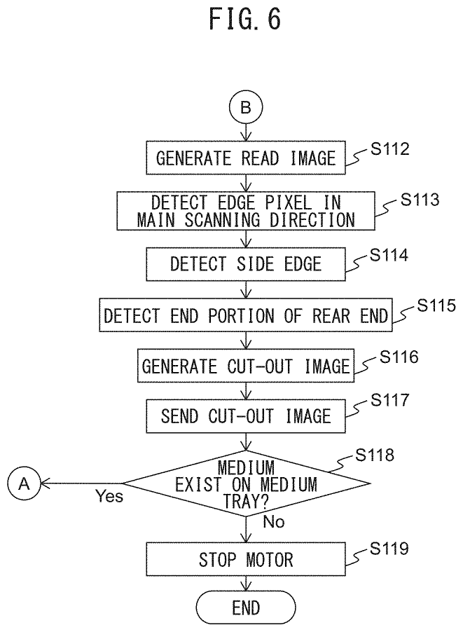

FIGS. 5 and 6 are flowcharts illustrating an operation example of medium reading processing of the image reading apparatus 100.

Referring to the flowchart illustrated in FIGS. 5 and 6, the operation example of the medium reading processing in the image reading apparatus 100 will be described below. The operation flow described below is executed mainly by the processing circuit 150 in cooperation with each element in the image reading apparatus 100, in accordance with a program previously stored in the storage device 140. The flow of operations shown in FIGS. 5 and 6 is performed periodically.

First, the control module 151 stands by until an instruction to read a medium is input by a user by use of the operation device 105, and an operation signal instructing to read the medium is received from the operation device 105 (step S101).

Next, the control module 151 determines whether or not a medium is placed on the medium tray 103, based on a first medium signal received from the first medium sensor 111 (step S102).

When a medium is not placed on the medium tray 103, the control module 151 returns the processing to step S101 and stands by until newly receiving an operation signal from the operation device 105.

On the other hand, when the medium is placed on the medium tray 103, the control module 151 drives the motor 131 to rotate the feed roller 112, the brake roller 113, and the first to fourth conveying rollers 114, 115, 118 and 119 to convey the medium (step S103).

Next, the image acquisition module 152 causes the imaging device 117 to image the conveyed medium and acquires a line image (step S104). The image acquisition module 152 may determine whether or not a front end of the medium passed through a position of the second medium sensor 116 based on the second medium signal received from the second medium sensor 116, and cause the imaging device 117 to start imaging when the front end of the medium passed through the position of the second medium sensor 116. The image acquisition module 152 acquires the second medium signal periodically from the second medium sensor 116, and determines that the front end of the medium passed through the position of the second medium sensor 116 when a signal value of the second medium signal changes from a value indicating that a medium is not present to a value indicating that a medium is present.

Next, the image acquisition module 152 determines whether or not an end portion in the main scanning direction of the front end of the medium has been detected by the end portion detection module 154 (step S105). The end portion in the main scanning direction of the front end of the medium is detected in step S109 described below. When the end portion in the main scanning direction of the front end of the medium has been already detected, the image acquisition module 152 proceeds the processing to the step S111.

On the other hand, when the end portion in the main scanning direction of the front end of the medium has not been detected, the image acquisition module 152 determines whether or not a predetermined number of line images has been acquired from the imaging device 117 (step S106). The predetermined number is preset to a value of one or more (e.g., 100) wherein the predetermined number of line images is considered to reliably include the end portion in the main scanning direction of the front end of the medium. The predetermined number may be set to a value wherein the predetermined number of line images include the entire medium. The image reading apparatus 100 can detect the end portion more reliably as the predetermined number increases, and can detect the end portion at an earlier stage as the predetermined number decreases. When the predetermined number of line images has not been acquired, the image acquisition module 152 returns the processing to step S104 and repeats the processing of step S104 to S106.

On the other hand, when the predetermined number of line images are acquired, the image acquisition module 152 generates an input image by synthesizing the predetermined number of line images (step S107). That is, the input image is an image acquired by imaging the medium by the imaging device 117, and generated by the image acquisition module 152. The imaging device 117 may generate the input image by synthesizing the predetermined number of line images, and the image acquisition module 152 may acquire the input image from the imaging device 117.

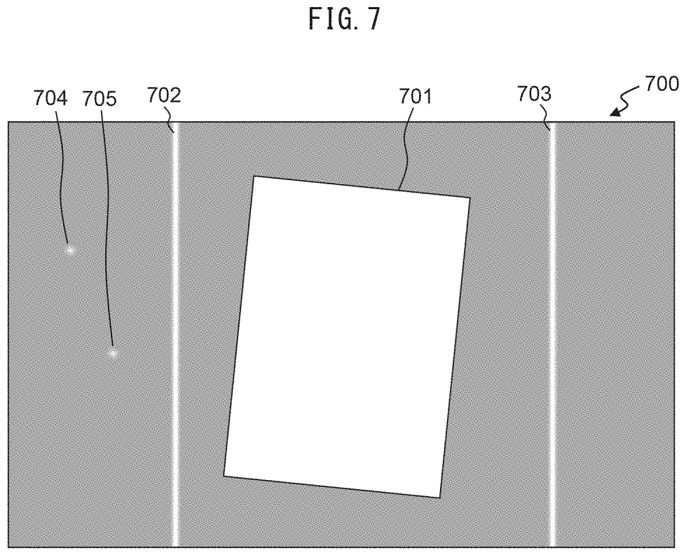

FIG. 7 is a schematic diagram illustrating an example of an input image 700.

The input image 700 illustrated in FIG. 7 includes a medium 701, and further includes vertical streak noises 702, 703 and sudden noises 704, 705 in a background portion. The vertical streak noises 702, 703 are noises generated by foreign matter such as paper dust, dust, glue, etc., adhering on an imaging surface (a glass surface) of the imaging device 117, or sensitivity unevenness, etc., of the line sensor. The sudden noise is a noise generated when amplifying an electrical signal output from the imaging element in the imaging device 117, or a noise generated due to a difference in the characteristics of each component, etc.

Next, the edge pixel detection module 153 detects a plurality of edge pixels in the sub-scanning direction from the input image (step S108). The edge pixel detection module 153 detects the edge pixels in the sub-scanning direction based on gradation values of a plurality of pixels of which positions in the main scanning direction are mutually the same and a distance between pixels in the sub-scanning direction is within a predetermined range in the input image.

The edge pixel detection module 153 calculates an absolute value (hereinafter, referred to as an adjacent difference value) of the difference between the gradation values of both adjacent pixels in the vertical direction of each pixel in each vertical line, in order from the upper end side, for each vertical line extending in the vertical direction (the sub-scanning direction) in the input image. The edge pixel detection module 153 detects a pixel whose adjacent difference value exceeds a gradation threshold in each vertical line as the edge pixel. The edge pixel detection module 153 sets an edge pixel initially detected in each vertical line, that is, an edge pixel located at the uppermost side, as an upper end edge pixel, and detects the pixel as the edge pixel in the sub-scanning direction. The gradation value is a luminance value or a color value (R value, G value or B value). For example, the gradation threshold value may be set to a difference in brightness value (for example, 20) according to which a person may determine a difference in brightness on an image by visual observation.

The edge pixel detection module 153 may calculate the absolute value of the difference between the gradation values of the two pixels separated each other by a predetermined distance in the vertical direction in the input image as the adjacent difference value. Further, the edge pixel detection module 153 may detect the edge pixel by comparing the gradation value of each pixel in the input image with the threshold value. For example, the edge pixel detection module 153 detects a specific pixel as the edge pixel when the gradation value of the specific pixel is less than the threshold value and the gradation value of the pixel adjacent to the specific pixel in the vertical direction or the pixel separated by a predetermined distance in the vertical direction is equal to or more than the threshold value.

The edge pixel detection module 153 may detect the edge pixels in the sub-scanning direction at regular intervals (for example, 4 pixels) in the main scanning direction in the input image, instead of detecting the edge pixels in the sub-scanning direction for all the pixels in the input image. The edge pixel detection module 153 extracts a target line for detecting the edge pixel in the sub-scanning direction from among the vertical lines in the input image at regular intervals, and detects the edge pixel in the sub-scanning direction for the extracted target line. Thus, the edge pixel detection module 153 can reduce the time required for detecting the end portion of the medium, and can reduce the processing time and the processing load of the medium reading processing.

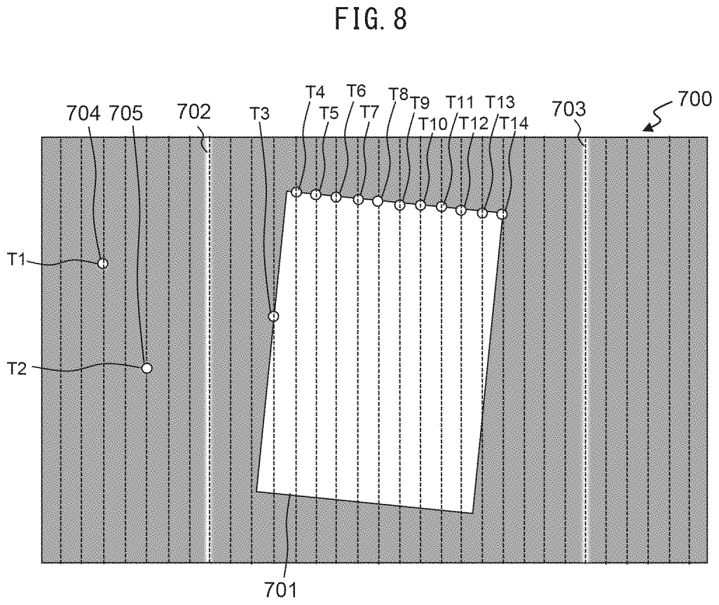

FIG. 8 is a schematic diagram for illustrating an upper end edge pixel.

In FIG. 8, the input image 700 illustrated in FIG. 7 is illustrated. In FIG. 8, a dotted line extending vertically indicates the vertical line extracted as the target line. In the example illustrated in FIG. 8, the pixels T1 to T14 are detected as the upper end edge pixels. The upper end edge pixel T1, T2 are pixels corresponding to the sudden noises 704, 705, respectively. The upper end edge pixel T3 is a pixel corresponding to the left side of the medium. The upper end edge pixels T4 to T14 are pixels corresponding to the upper side of the medium. As illustrated in FIG. 8, since each of the vertical streak noises 702, 703 extend in the vertical direction and the gradation value of each pixel in each of the vertical streak noises 702, 703 is within a certain range, the pixel corresponding to each of the vertical streak noises 702, 703 is not detected as the upper end edge pixel. The vertical streak noise generated or disappeared in the middle of reading (in the middle of medium conveying) is detected similarly to the sudden noises 704, 705 since it has a change in the gradation value at its end. The vertical streak noise generated or disappeared in the middle of such reading (in the middle of medium conveying) is processed in the same manner as the sudden noises 704, 705 in the processing to be described later, and is not erroneously detected as the end portion of the medium.

Next, the end portion detection module 154 detects the end portion in the main scanning direction of the front end of the medium based on the edge pixels in the sub-scanning direction (step S109). The end portion detection module 154 detects the end portion in the main scanning direction of the front end of the medium based on a positional relationship between each of the plurality of edge pixels in the sub-scanning direction detected by the edge pixel detection module 153.

For example, the end portion detection module 154 calculates the number or a ratio of the edge pixels in the sub-scanning direction within a certain range in the main scanning direction, that is, a density of the edge pixels in the sub-scanning direction within the certain range in the main scanning direction, as the positional relationship between each of the plurality of edge pixels in the sub-scanning direction. The end portion detection module 154 calculates, for each target line extracted from the vertical line, the number or the ratio of the target lines in which the edge pixels in the sub-scanning direction are detected among the target lines located within the certain range from each target line. The certain range is set so that the number of the calculation target of the number or the ratio is a predetermined number (e.g., 5) of 2 or more. The end portion detection module 154 extracts a target line group in which the calculated number is a threshold value (e.g., 3) or more target lines, or the calculated ratio is a threshold value (e.g., 0.6) or more target lines are continuously adjacent to each other.

The end portion detection module 154 detects a range in the main scanning direction of the target line group having the largest number of target lines among the extracted target line groups as a front end range of the medium in the main scanning direction. The end portion detection module 154 may detect a range reduced by a predetermined margin from the detected range, or a range enlarged by a predetermined margin from the detected range as the front end range of the medium in the main scanning direction. The end portion detection module 154 detects positions of both ends of the target line group detected as the front end range of the medium in the main scanning direction as the end portions in the main scanning direction of the front end of the medium.

In the example illustrated in FIG. 8, the range from the target line including the upper end edge pixel T3 to the target line including the upper end edge pixel T14 is detected as the tip range of the medium. Then, the target line including the upper end edge pixel T3, and the target line including the upper end edge pixel T14 is detected as an end portion in the main scanning direction of the front end of the medium. That is, since the pixels corresponding to the vertical streak noises 702, 703 are not detected as the upper end edge pixel, it is not included in the front end range of the medium. Further, since the target line including the upper end edge pixels T1, T2 corresponding to the sudden noises 704, 705 is located discretely, it is not included in the front end range of the medium. Even when the difference between the gradation values of the background and the medium is small in a part of the target lines among the target lines corresponding to the front end of the medium and the upper end edge pixel is not detected, when the upper end edge pixel is detected in the target lines around part of the target lines, the part of the target lines are also included in the front end range of the medium. The end portion detection module 154 can detect the front end range of the medium and the end portion with high accuracy by reducing the influence of noise and the influence of detection leakage of the upper end edge pixel by using the number or the ratio of the edge pixels in the sub-scanning direction within the certain range.

The end portion detection module 154 may detect the edge pixels in the sub-scanning direction continuously detected in the main scanning direction as the positional relationship between each of the plurality of edge pixels in the sub-scanning direction. In that case, the end portion detection module 154 calculates the number (continuous number) of edge pixels in the sub-scanning direction that are continuously detected in the main scanning direction. The end portion detection module 154 extracts the target line group including a predetermined number (e.g., three) or more of target lines continuously adjacent to each other in which the edge pixels in the sub-scanning direction are detected.

The end portion detection module 154 detects a range in the main scanning direction of the target line group having the largest number of target lines among the extracted target line groups as a front end range of the medium in the main scanning direction. The end portion detection module 154 may detect a range reduced by a predetermined margin from the detected range, or a range enlarged by a predetermined margin from the detected range as the front end range of the medium in the main scanning direction. The end portion detection module 154 detects positions of both ends of the target line group detected as the front end range of the medium in the main scanning direction as the end portions in the main scanning direction of the front end of the medium.

In the example illustrated in FIG. 8, the range from the target line including the upper end edge pixel T3 to the target line including the upper end edge pixel T14 is detected as the tip range of the medium. Then, the target line including the upper end edge pixel T3, and the target line including the upper end edge pixel T14 is detected as an end portion in the main scanning direction of the front end of the medium. That is, since the pixels corresponding to the vertical streak noises 702, 703 are not detected as the upper end edge pixel, it is not included in the front end range of the medium. Further, since the target line including the upper end edge pixels T1, T2 corresponding to the sudden noises 704, 705 is located discretely, it is not included in the front end range of the medium. In this case, when the upper end edge pixel is not detected in a part of the target lines among the target lines corresponding to the front end of the medium, the front end range of the medium is not detected correctly. However, the continuous number of edge pixels in the sub-scanning direction is calculated in a shorter time than the number or the ratio of edge pixels in the sub-scanning direction within the certain range. Accordingly, the end portion detection module 154 can detect the front end range of the medium and the end portion thereof in a shorter time and at a lower load while reducing the influence of noise, based on the edge pixels in the sub-scanning direction that are continuously detected in the main scanning direction.

Further, the end portion detection module 154 may calculate, as the positional relationship between each of the plurality of edge pixels in the sub-scanning direction, an approximability of the position in the sub-scanning direction. For example, the end portion detection module 154 calculates a distance in the sub-scanning direction between each of the plurality of edge pixels in the sub-scanning direction as the approximability of the position in the sub-scanning direction. The end portion detection module 154 extracts a target line group in which the target lines on which the edge pixels in the sub-scanning direction are detected are positioned within a first distance mutually in the main scanning direction and the edge pixels in the sub-scanning direction detected in each target line are positioned within a second distance in the sub-scanning direction. The first distance is set to, for example, a predetermined multiple (e.g., twice) of the distance between the target lines adjacent to each other. The second distance is set to, for example, a predetermined multiple (e.g., twice) of the distance between the target lines adjacent to each other.

The end portion detection module 154 detects a range in the main scanning direction of the target line group having the largest number of target lines among the extracted target line groups as a front end range of the medium in the main scanning direction. The end portion detection module 154 may detect a range reduced by a predetermined margin from the detected range, or a range enlarged by a predetermined margin from the detected range as the front end range of the medium in the main scanning direction. The end portion detection module 154 detects positions of both ends of the target line group detected as the front end range of the medium in the main scanning direction as the end portions in the main scanning direction of the front end of the medium.

In the example illustrated in FIG. 8, the range from the target line including the upper end edge pixel T4 to the target line including the upper end edge pixel T14 is detected as the tip range of the medium. That is, since the pixels corresponding to the vertical streak noises 702, 703 are not detected as the upper end edge pixel, it is not included in the front end range of the medium. Further, since the target line including the upper end edge pixels T1, T2 corresponding to the sudden noises 704, 705 is located discretely, it is not included in the front end range of the medium. Further, since the upper end edge pixel T3 corresponding to the left side of the medium 701 is apart from, in the main scanning direction, the upper end edge pixels T4, T5 positioned in the vicinity in the sub-scanning direction, the target line including the upper end edge pixel T3 is not included in the front end range of the medium. Even when the sudden noise is generated in the vicinity of the medium in the main scanning direction, when the sudden noise is apart from the front end of the medium in the sub-scanning direction, the sudden noise is not included in the front end range of the medium. By using the distance in the sub-scanning direction between the edge pixels in the sub-scanning direction, the end portion detection module 154 can detect the front end range of the medium and the end portion thereof with high accuracy by reducing the influence of noise and the influence of the side edge of the medium.

Further, the end portion detection module 154 may calculate a frequency of the edge pixels in the sub-scanning direction for a plurality of lines of the main scanning direction as the approximability of the position in the sub-scanning direction. The end portion detection module 154 calculates the number of edge pixels in the sub-scanning direction detected on the line in the main scanning direction for each line in the main scanning direction. The end portion detection module 154 generates a histogram in which a position in the sub-scanning direction of each line in the main scanning direction is set as a class and the number calculated for each line in the main scanning direction is set as a frequency. The end portion detection module 154 extracts the target line in which the edge pixel in the sub-scanning direction is detected within the class range in which the frequency is equal to or more than a frequency threshold in the generated histogram, as the target line group. The frequency threshold is set to a predetermined value in advance (e.g., 3). The frequency threshold may be dynamically set in accordance with the generated histogram. In that case, the frequency threshold is set to, for example, ½ of the maximum frequency.

The end portion detection module 154 detects a range in the main scanning direction of the extracted target line group as the front end range of the medium in the main scanning direction. The end portion detection module 154 may detect a range reduced by a predetermined margin from the detected range, or a range enlarged by a predetermined margin from the detected range as the front end range of the medium in the main scanning direction. The end portion detection module 154 detects positions of both ends of the target line group detected as the front end range of the medium in the main scanning direction as the end portions in the main scanning direction of the front end of the medium.

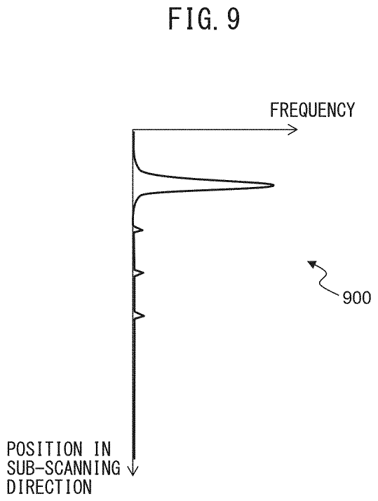

FIG. 9 is a schematic diagram for illustrating a histogram 900 generated by the end portion detection module 154.

In FIG. 9, the histogram 900 generated from the input image 700 illustrated in FIG. 7 is illustrated. In FIG. 9, the vertical axis indicates a position (class) in the sub-scanning direction of each line in the main scanning direction, and the horizontal axis indicates the number (frequency) calculated for each line in the main scanning direction. In the example illustrated in FIG. 9, in the sub-scanning direction, the frequency is increased in the range in which the upper end edge pixels T4 to T14 corresponding to the upper side of the medium exist. On the other hand, the frequency is decreased at a position where the upper end edge pixels T1, T2 corresponding to the sudden noises 704, 705, and the upper end edge pixel T3 corresponding to the left side of the medium exist.

Therefore, in the example illustrated in FIG. 8, the range from the target line including the upper end edge pixel T4 to the target line including the upper end edge pixel T14 is detected as the tip range of the medium. That is, the target line including the upper end edge pixels T1, T2 corresponding to the sudden noises 704, 705, and the upper end edge pixel T3 corresponding to the left side of the medium 701 is not included in the front end range of the medium. By using the frequency of the edge pixels in the sub-scanning direction for each line in the main scanning direction, the end portion detection module 154 can detect the front end range of the medium and the end portion thereof with high accuracy by reducing the influence of noise and the influence of the side edges of the medium.

Next, the medium width detection module 155 detects the medium width based on the end portion in the main scanning direction of the front end of the medium detected by the end portion detection module 154 (step S110). For example, the medium width detection module 155 detects the Euclidean distance between both ends in the main scanning direction of the front end of the medium as the medium width. The medium width detection module 155 calculates the Euclidean distance W between both ends in the main scanning direction of the front end of the medium according to the following equation (1).

### [Equation 1]

W=\sqrt{(x₂−x₁)²+(y₂−y₁)²} (1)

Here, (x1, y1) are the coordinates of one end in the main scanning direction of the front end of the medium in the coordinate system in which the main scanning direction is the x-axis and the sub-scanning direction is the y-axis in the input image, and (x2, y2) are the coordinates of the other end in the main scanning direction of the front end of the medium in the coordinate system. The image reading apparatus 100 may store in advance a table indicating a relationship between the coordinates of each end portion and the Euclidean distance, and the medium width detection module 155 may acquire the Euclidean distance by referring to the table.

The medium width detection module 155 may detect a distance in the main scanning direction between both ends in the main scanning direction of the front end of the medium as the medium width. In that case, the medium width detection module 155 calculates the distance W in the main scanning direction between both ends in the main scanning direction of the front end of the medium according to the following equation (2).

### [Equation 2]

W=|x₂−x₁| (2)

Next, the image acquisition module 152 determines whether or not the entire medium has been imaged (step S111). The image acquisition module 152, for example, determines whether or not the rear end of the medium has passed through the position of the second medium sensor 116 based on the second medium signal received from the second medium sensor 116. The image acquisition module 152 acquires the second medium signal periodically from the second medium sensor 116, and determines that the rear end of the medium passed through the position of the second medium sensor 116 when a signal value of the second medium signal changes from a value indicating that a medium is present to a value indicating that a medium is not present. The image acquisition module 152 determines that the rear end of the medium has passed through the imaging position of the imaging device 117, and the entire medium has been imaged when a predetermined time elapsed since the rear end of the medium passed through the position of the second medium sensor 116. The image acquisition module 152 may determine that the entire conveyed medium has been imaged when a predetermined number of line images are acquired from the imaging device 117.

When the entire conveyed medium has not been imaged, the image acquisition module 152 returns the processing to step S104 and repeats the processing of step S104 to S111.

On the other hand, when the entire conveyed medium has been imaged, the image acquisition module 152 generates the read image by combining all the acquired line images (step S112). When the number of lines (a predetermined number) included in the input image is set to a value including the entire medium, the image acquisition module 152 may use the input image as the read image.

Next, the side edge detection module 156 detects the edge pixel in the main scanning direction from the read image (step S113). The side edge detection module 156 detects the edge pixels in the main scanning direction based on gradation values of a plurality of pixels of which positions in the sub-scanning direction are mutually the same and a distance between pixels in the main scanning direction is within a predetermined range in the read image.

The side edge detection module 156 calculates an absolute value (hereinafter, referred to as an adjacent difference value) of a difference between the gradation values of both adjacent pixels in the horizontal direction of each pixel in each horizontal line, in order from the left end side, for each horizontal line extending in the horizontal direction (the main scanning direction), in the read image. The side edge detection module 156 detects a pixel whose adjacent difference value exceeds the gradation threshold in each horizontal line as the edge pixel. The side edge detection module 156 sets the edge pixel first detected in each horizontal line, i.e. the edge pixel located on the leftmost side as the left end edge pixel, and sets the edge pixel last detected in each horizontal line, i.e. the edge pixel located on the rightmost side as the right end edge pixel. The side edge detection module 156 may detect the edge pixels in order from the right end, and set the first detected edge pixel in each horizontal line as the right end edge pixel. The side edge detection module 156 detects the left end edge pixel and the right end edge pixel as the edge pixel in the main scanning direction.

The side edge detection module 156 may calculate the absolute value of the difference between the gradation values of the two pixels separated each other by a predetermined distance in the horizontal direction from each pixel in the read image as the adjacent difference value. Further, the side edge detection module 156 may detect the edge pixel by comparing the gradation value of each pixel in the read image with the threshold value. For example, the side edge detection module 156 detects a specific pixel as the edge pixel when the gradation value of the specific pixel is less than the threshold value and the gradation value of the pixel adjacent to the specific pixel in the vertical direction or the pixel separated by a predetermined distance in the horizontal direction is equal to or more than the threshold value.

Further, the side edge detection module 156 may detect the edge pixels in the main scanning direction at regular intervals (e.g., 4 pixels) in the sub-scanning direction in the read image instead of detecting the edge pixels in the main scanning direction for all the pixels in the read image. The side edge detection module 156 extracts target lines for detecting the edge pixel in the main scanning direction from among the horizontal lines in the read image at the regular intervals, and detects the edge pixel in the main scanning direction for the extracted target line. Thus, the side edge detection module 156 can reduce the time required for detecting the edge of the medium, and can reduce the processing time and the processing load of the medium reading processing.

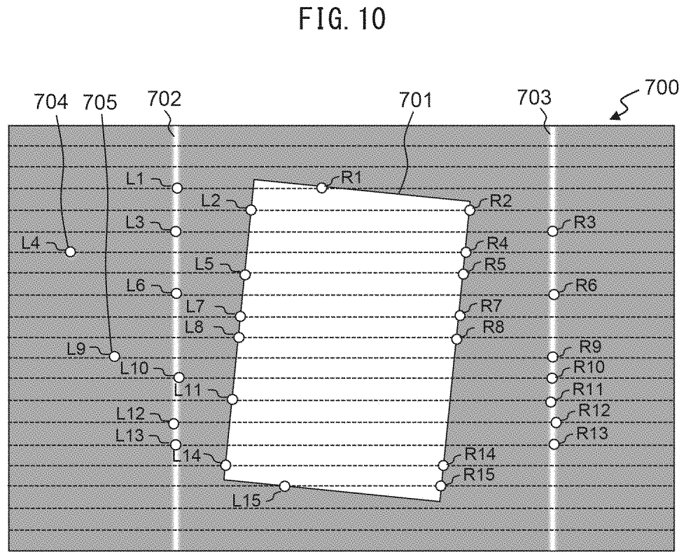

FIG. 10 is a schematic diagram for illustrating the left end edge pixel and the right end edge pixel.

In FIG. 10, the input image 700 illustrated in FIG. 7 is illustrated. In FIG. 10, a dotted line extending horizontally indicates the horizontal line extracted as the target line. In the illustrated shown in FIG. 10, the pixels L1 to L15 are detected as the left end edge pixels, and the pixels R1 to R15 are detected as the right end edge pixels. The left end edge pixels L1, L3, L6, L10, L12 and L13 are pixels corresponding to the vertical streak noise 702, respectively. The left end edge pixels L2, L5, L7, L8, L11 and L14 are pixels corresponding to the left side of the medium, respectively. The left end edge pixels L4, L9 are pixels corresponding to the sudden noises 704, 705, respectively. The left end edge pixel L15 is a pixel corresponding to the lower side of the medium. The right end edge pixel R1 is a pixel corresponding to the upper side of the medium. The right end edge pixel R2, R4, R5, R7, R8, R14 and R15 are pixels corresponding to the right side of each medium. The right end edge pixels R3, R6, R9, R10, R11, R12 and R13 are pixels corresponding to the vertical streak noise 703, respectively.

Next, the side edge detection module 156 detects a side edge of the medium based on the edge pixel in the main scanning direction and the end portion in the main scanning direction of the front end of the medium detected by the end portion detection module 154 (step S114).

At first, the side edge detection module 156 groups the extracted left end edge pixel and the extracted right end edge pixel, respectively. For example, the side edge detection module 156 summarizes the left end edge pixel located around a specific straight line in the same group, and summarizes the right end edge pixel located around a specific straight line, respectively.

For example, the side edge detection module 156 sets the left end edge pixel located at the uppermost end side among the extracted left end edge pixels to the target pixel. The side edge detection module 156 scans the left end edge pixels toward the lower end side. When an inclination of a straight line passing through the target pixel and a specific left end edge pixel is equal to or less than a predetermined angle (e.g., 45°), the side edge detection module 156 extracts the specific left end edge pixel as a candidate pixel, and sets the straight line as a candidate straight line. When there is a left end edge pixel further on the lower end side of the candidate pixel, to which the distance from the candidate straight line is equal to or less than a predetermined distance, the side edge detection module 156 summarizes the left end edge pixels to which the distance from the target pixel, the candidate pixel, and the candidate straight line is equal to or less than the predetermined distance, in one group. The side edge detection module 156 does not group the target pixels when the candidate pixels are not extracted or when there is no left end edge pixel on the lower end side of the candidate pixel, to which distance from the candidate straight line is equal to or less than the predetermined distance. The side edge detection module 156 repeats the same processing for the left end edge pixel not summarized in the group. Further, the side edge detection module 156 executes the same processing for the right end edge pixel.

In the example illustrated in FIG. 10, since the left end edge pixels L1, L3, L6, L10, L12 and L13 are located in a substantially straight line, and located around the same straight line, they are summarized in the same group. Similarly, since the left end edge pixels L2, L5, L7, L8, L11 and L14 are located in a substantially straight line, and located around the same straight line, they are summarized in the same group. The left end edge pixels L4, L9 and L15 are not grouped, since there is no straight line around which the other two or more left end edge pixels are located.

Further, since the right end edge pixels R2, R4, R5, R7, R8, R14 and R15 are located in a substantially straight line, and located around the same straight line, they are summarized in the same group. Similarly, since the right end edge pixels R3, R6, R9, R10, R11, R12 and R13 are located in a substantially straight line, and located around the same straight line, they are summarized in the same group. The right end edge pixel R1 is not grouped, since there is no straight line around which the other two or more right end edge pixels are located.

Next, the side edge detection module 156 extracts, among each group, a group having the smallest distance between the candidate straight line and the end portion in the main scanning direction of the front end of the medium detected by the end portion detection module 154 as a group corresponding to the side edge of the medium. The side edge detection module 156 detects a straight line passing through each edge pixel included in the extracted group as the side edge of the medium, using the least squares method. The side edge detection module 156 may detect a straight line passing through each edge pixel included in the extracted group as the side edge of the medium, using the Huff transform.

In the example illustrated in FIG. 10, the group of the left end edge pixels L2, L5, L7, L8, L11 and L14, and the group of the right end edge pixels R2, R4, R5, R7, R8, R14 and R15 are respectively extracted as the group corresponding to the side edges of the medium. Thus, the side edge detection module 156 can detect the side edge of the medium with high accuracy without being affected by vertical streak noise etc., by detecting the side edge of the medium based on the end portion in the main scanning direction of the front end of the medium detected by the end portion detection module 154. That is, the side edge detection module 156 can improve the reliability of the side of the detected medium.

The side edge detection module 156 may detect the side of the medium by another method. For example, the side edge detection module 156 detects the left end edge pixel and the right end edge pixel within an area within a predetermined distance from the two ends in the main scanning direction of the front end of the medium detected by the end portion detection module 154 in the main scanning direction. The side edge detection module 156 detects a straight line passing through the detected left end edge pixel, and a straight line passing through the detected right end edge pixel as the side edge of the medium. In this case, the side edge detection module 156 can also detect the side edge of the medium with high accuracy without being affected by vertical streak noise, etc.

Next, the end portion detection module 154 detects the end portion in the main scanning direction of the rear end of the medium (step S115). The edge pixel detection module 153 detects the edge pixel in the input image or the read image in the same manner as in step S108, and detects the edge pixel located at the lowermost side in each vertical line as the lower end edge pixel (the edge pixel in the sub-scanning direction). The end portion detection module 154 detects the end portion in the main scanning direction of the rear end of the medium based on the lower end edge pixel in the same manner as in step S109.

Next, the output control module 157 generates a cut-out image acquired by cutting out an area of the medium from the read image (step S116). The output control module 157 detects a straight line passing through the upper end edge pixel as the upper side of the medium, and detects a straight line passing through the lower end edge pixel as the lower side of the medium, using the least squares method or the Huff transform. The output control module 157 detects an area surrounded by the detected upper side and lower side, and two sides of the medium detected by the side edge detection module 156 as an area of the medium. The output control module 157 generates the cut-out image by cutting out the area of the detected medium.

Next, the output control module 157 outputs by transmitting the generated cut-out image to the information processing apparatus via the interface device 132 (step S117). The output control module 157 may be output by displaying the generated cut-out image on the display device 106. The side edge of the medium in the cut-out image is detected based on the end portion of the front end of the medium detected by the end portion detection module 154, and the cut-out image is an example of information relating to the end portion detected by the end portion detection module 154. The output control module 157 may transmit the read image to the information processing apparatus without generating the cut-out image, and transmit the coordinates indicating the position of the end portion of the front end of the medium detected by the end portion detection module 154 in the read image to the information processing apparatus as information relating to the end portion. In this case, the information processing apparatus generates the cut-out image from the read image based on the received coordinates.

Further, in step S109, the output control module 157 may determine whether the medium is a card or a paper based on the end portion of the front end of the medium detected by the end portion detection module 154. In that case, the output control module 157 determines that the media is a card when the distance between the end portions of the front end of the media is equal to or less than a threshold value, and the output control module 157 determines that the media is a paper when the distance between the end portions of the front end of the media is more than the threshold value. The threshold value is set, for example, to a value acquired by adding a margin to the longitudinal size of the card defined by ISO/IEC7810. The output control module 157 transmits information indicating whether the medium is a card or a paper to the information processing device as information relating to the end portion of the medium. In this case, the information processing apparatus classifies the received image according to whether the medium is a card or a paper. Further, the output control module 157 may periodically determines whether or not the multi-feed of the conveyed medium has occurred based on the ultrasonic signal output from the ultrasonic sensor (not shown), and stop conveying the medium when the multi-feed of the medium has occurred. In that case, the output control module 157 may determine that the multi-feed of the medium has not occurred when the medium is a card. Thus, the output control module 157 can suppress erroneous determination that the multi-feed of the medium has occurred when the card is conveyed.

Further, the output control module 157 may detect the size of the medium based on the end portion of the front end of the medium detected by the end portion detection module 154, and change rotation speeds of the third conveying roller 118 and the fourth conveying roller 119 (ejection speed of the medium) according to the detected size of the medium. In that case, the output control module 157 detects a distance between the end portions of the front end of the medium as the size of the medium. Then, the output control module 157 changes the rotation speed of the motor 131 to change the rotation speeds of the third conveying roller 118 and the fourth conveying roller 119 according to the detected size of the medium, when it is determined that the entire medium is imaged in step S111. The output control module 157 change the rotation speed of the motor 131 so that the smaller the size of the medium is, the lower (slower) the rotation speed is, and the larger the size of the medium is, the higher (faster) the rotation speed is. Thus, the image reading apparatus 100 can suppress the medium having a small size from being ejected vigorously and scattered on the ejection tray 104, thereby improve the alignability of the medium in the ejection tray 104.

Further, in step S109, the output control module 157 may determine whether or not the skew of the medium has occurred based on the end portion of the front end of the medium detected by the end portion detection module 154. In this case, the image reading apparatus 100 stores a table in which a range of a position of the end portion of the front end of the medium and a range of an inclination (an angle with respect to the main scanning direction) of the front end of the medium, in which the skew of the medium is considered to have occurred, are set, in advance in the storage device 140. The output control module 157 calculates an inclination of the straight line passing through the two ends of the front end of the medium detected by the end portion detection module 154. The output control module 157 determine whether or not the skew of the medium has occurred, depending on whether or not the two ends of the front end of the medium detected by the end portion detection module 154 and the calculated inclination are included in the range set in advance. When the output control module 15 determines that the skew of the medium has occurred, the output control module 157 stops the motor 131 to stop the conveyance of the medium, and outputs information indicating that a conveyance abnormality of the medium has occurred as information relating to the end portion of the medium, to notify the user of it.

Next, the control module 151 determines whether or not a medium remains on the medium tray 103 based on the first medium signal received from the first medium sensor 111 (step S118). When a medium remains on the medium tray 103, the control module 151 returns the processing to step S104 and repeats the processing in step S104 to S118.

On the other hand, when a medium does not remain on the medium tray 103, the control module 151 stops the motor 131 (step S119) and ends the series of steps.

The processing in step S110 may be omitted. Further, the processing of steps S113 to S116 is omitted, and in step S117, the output control module 157 may output the read image.

As described in detail above, the image reading apparatus 100 detects the end portion in the main scanning direction of the front end of the medium based on the positional relationship between each of the plurality of edge pixels in the sub-scanning direction (the density in the main scanning direction, the continuous number in the main scanning direction, and the approximability of the positions in the sub-scanning direction). That is, the image reading apparatus 100 detects the end portion in the main scanning direction of the front end of the medium based on groupability of the plurality of edge pixels in the sub-scanning direction. Thus, the image reading apparatus 100 can detect the end portion in the main scanning direction of the front end or the rear end of the medium from the image with high accuracy by reducing the influence of the vertical streak noise and the sudden noise, etc.

In particular, the image reading apparatus 100 can reduce the influence of the vertical streak noise even when the foreign matter in the image cannot be removed using the reference image acquired in advance, as in the case where the foreign matter adheres to or peels off the imaging device 117 during the medium reading.

Further, since the image reading apparatus 100 detects the end portion in the main scanning direction of the front end of the medium before the entire medium is imaged, based on the input image including a predetermined number of line images, the image reading apparatus 100 can detect the end portion in the main scanning direction of the front end of the medium at an early stage (in real time).

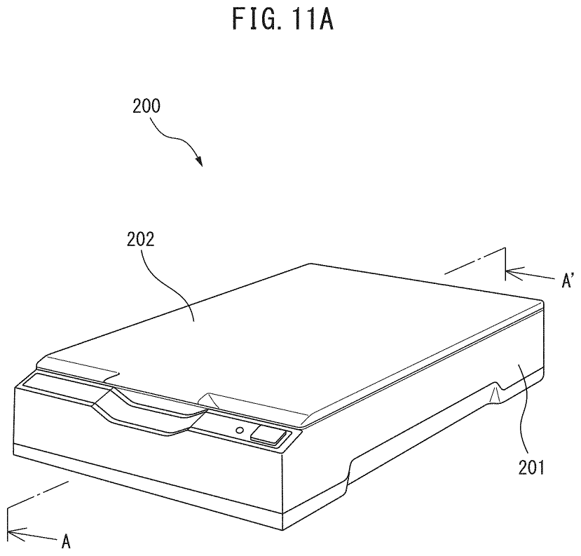

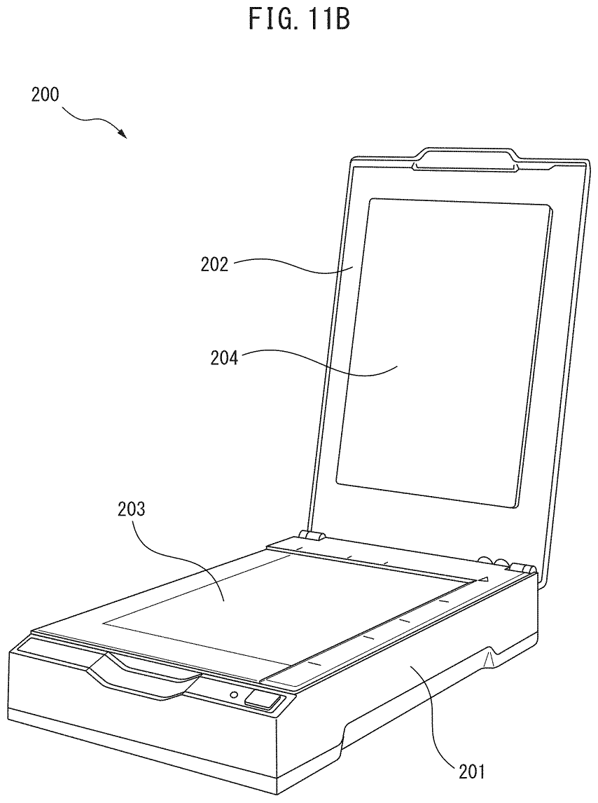

FIG. 11A and FIG. 11B are perspective views illustrating an image reading apparatus 200 according to another embodiment. FIG. 11A is a perspective view of the image reading apparatus 200 in a state in which the cover 202 is closed, and FIG. 11B is a perspective view of the image reading apparatus 200 in a state in which the cover 202 is open.

As illustrated in FIG. 11A and FIG. 11B, the image reading apparatus 200 is, for example, a flatbed-type scanner, etc. The image reading apparatus 200 includes a housing 201, a cover 202, etc.

The housing 201 has a glass plate 203, etc. The glass plate 203 is a member for placing the medium, and is provided on an upper surface of the housing 201. The plate 203 forms a mounting surface of the medium.

The cover 202 has a reference member 204, etc. The cover 202 is provided to be opened and closed with respect to the housing 201. In an open state, the cover 202 can place the medium on the glass plate 203 of the housing 201. In a closed state, the reference member 204 face the imaging device provided below the glass plate 203 (in the housing 201).

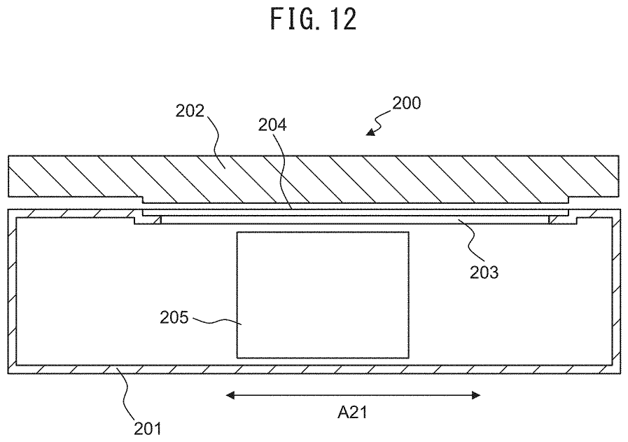

FIG. 12 is a cross-sectional view taken along an A-A′ line in FIG. 11A of the image reading apparatus 200 with the cover 202 in the closed state.

As illustrated in FIG. 12, the housing 201 has an imaging device 205. The imaging device 205 is provided at a position facing the reference member 204 provided on the cover 202 in the closed state, across the glass plate 203. The imaging device 205 is parallel to the glass plate 203 and extends so as to image from one end of the glass plate 203 to the other end in a direction perpendicular to a direction of arrow A21 in FIG. 12 (a main scanning direction). Further, the imaging device 205 is movably provided along a direction of arrow A21 (a sub-scanning direction) so as to image from one end of the glass plate 203 to the other end.

The imaging device 205 is an example of an imaging device, and image the medium placed on the glass plate 203. The imaging device 205 has the structure similar to the imaging device 117 of the image reading apparatus 100.

The image reading apparatus 200 includes the respective portions of the image reading apparatus 100 illustrated in FIG. 3. However, the image reading apparatus 200 does not have the first medium sensor 111 and the second medium sensor 116, and has the imaging device 205 instead of the imaging device 117. Further, in the image reading apparatus 200, the motor 131 is provided so as to move the imaging device 205 through a moving mechanism such as a pulley, a belt, a gear, a rack, and a pinion, etc., rather than rotating a roller for conveying the medium.

The processing circuit 150 executes the medium reading processing illustrated in FIGS. 5 and 6. However, the processing of step S102 is omitted, the control module 151 proceeds the processing to step S103 when receiving the operation signal from the operation device 105. In step S103, the control module 151 drives the motor 131 to move the imaging device 205. Further, in step S111, the image acquisition module 152 determines that the entire conveyed medium has been imaged when the movement of the imaging device 205 over the entire width in the sub-scanning direction is completed. Further, the processing of step S118 is omitted, the control module 151 proceeds the processing to step S119 when the reading of one medium is completed. In step S119, the control module 151 stops the imaging device 205 by stopping the motor 131.

As described in detail above, the image reading apparatus 200 can detect the end portion in the main scanning direction of the front end or the rear end of the medium from the image with high accuracy even when the imaging device 205 moves to image the medium.

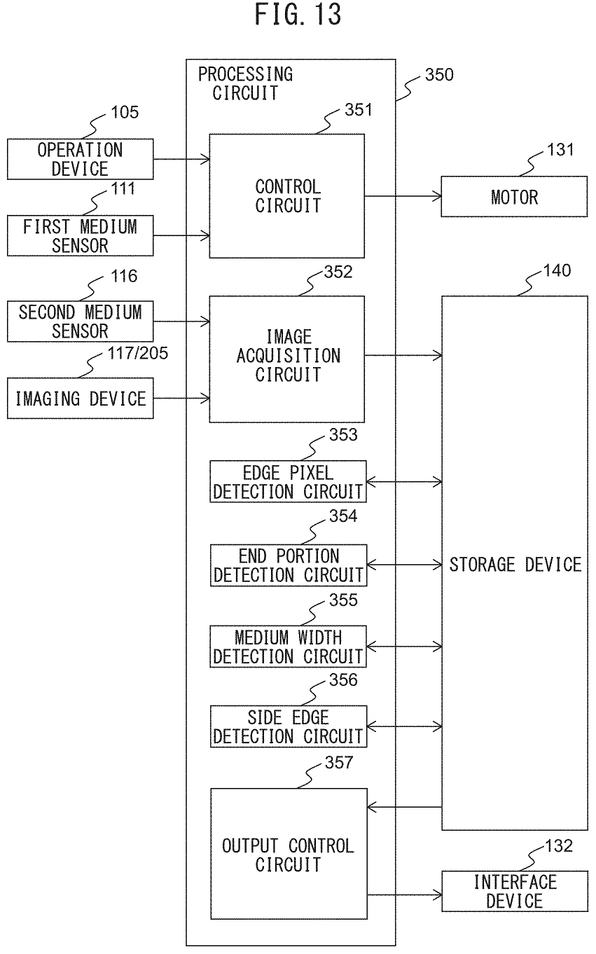

FIG. 13 is a diagram illustrating a schematic configuration of a processing circuit 350 in the image reading apparatus according to another embodiment. The processing circuit 350 is used in place of the processing circuit 150 of the image reading apparatus 100 or 200 to execute the medium reading processing. The processing circuit 350 includes a control circuit 351, an image acquisition circuit 352, an edge pixel detection circuit 353, an end portion detection circuit 354, a medium width detection circuit 355, a side edge detection circuit 356 and an output control circuit 357, etc. Note that each unit may be configured by an independent integrated circuit, a microprocessor, firmware, etc.

The control circuit 351 is an example of a control module, and has a function similar to the control module 151. The control circuit 351 receives the operation signal from the operation device 105, the first medium signal from the first medium sensor 111, and drives the motor 131 in response to each received signal, to control the conveyance of the medium or the movement of the imaging device 205.

The image acquisition circuit 352 is an example of an image acquisition module, and has a function similar to the image acquisition module 152. The image acquisition circuit 352 receives the second medium signal from the second medium sensor 116, receives the line image from the imaging device 117 or the imaging device 205 to generate the input image, and stores the line image and the input image in the storage device 140.

The edge pixel detection circuit 353 is an example of an edge pixel detection module, and has a function similar to the edge pixel detection module 153. The edge pixel detection circuit 353 reads the input image from the storage device 140, detects the edge pixel in the sub-scanning direction from the input image, and stores the detection result in the storage device 140.

The end portion detection circuit 354 is an example of an end portion detection module, and has a function similar to the end portion detection module 154. The end portion detection circuit 354 reads out the detection result of the input image and the edge pixel in the sub-scanning direction from the storage device 140, detects the end portion in the main scanning direction of the front end of the medium based on the edge pixel in the sub-scanning direction, and stores the detection result in the storage device 140.

The medium width detection circuit 355 is an example of a medium width detection module, and has a function similar to the medium width detection module 155. The medium width detection circuit 355 reads out the detection result of the end portion in the main scanning direction of the front end of the medium from the storage device 140, detects the medium width based on the end portion in the main scanning direction of the front end of the medium, and stores the detection result in the storage device 140.

The side edge detection circuit 356 is an example of a side edge detection module, and has a function similar to the side edge detection module 156. The side edge detection circuit 356 reads out the line image and the detection result of the end portion in the main scanning direction of the front end of the medium from the storage device 140, detects the side edge of the medium based on the end portion in the main scanning direction of the front end of the medium, and stores the detection result in the storage device 140.

The output control circuit 357 is an example of an output control module, and has a function similar to the output control module 157. The output control circuit 357 reads the line image from the storage device 140 to generate the read image. Further, the output control circuit 357 reads out the detection result of the end portion in the main scanning direction of the front end of the medium, generates the cut-out image based on the end portion in the main scanning direction of the front end of the medium, and transmits the cut-out image to the information processing apparatus (not shown) via the interface device 132.

As described in detail above, the image reading apparatus can detect the front end in the main scanning direction of the front end or the rear end of the medium from the image with high accuracy, even when the processing circuit 350 is used.

According to embodiment, the image reading apparatus, the control method, and the control program can detect the front end in the main scanning direction of the front end or the rear end of the medium from the image with higher accuracy.

What is claimed is:

1. An image reading apparatus comprising:
an imaging device to image a medium; and
a processor to
detect a plurality of edge pixels in a sub-scanning direction based on gradation values of a plurality of pixels of which positions in a main scanning direction are mutually the same and a distance between pixels in the sub-scanning direction is within a predetermined range in an input image acquired by imaging the medium by the imaging device, p2 detect an end portion in the main scanning direction of a front end or a rear end of the medium based on a positional relationship between the detected plurality of edge pixels in the sub-scanning direction, and
output information relating to the detected end portion.

2. The image reading apparatus according to claim 1, wherein the processor detects the end portion based on the number or a ratio of the edge pixels in the sub-scanning direction within a certain range in the main scanning direction.

3. The image reading apparatus according to claim 1, wherein the processor detects the end portion based on the edge pixels in the sub-scanning direction continuously detected in the main scanning direction.

4. The image reading apparatus according to claim 1, wherein the processor detects the end portion based on a distance in the sub-scanning direction between each of the plurality of edge pixels in the sub-scanning direction.

5. The image reading apparatus according to claim 1, wherein the processor detects the end portion based on a frequency of the edge pixels in the sub-scanning direction for a plurality of lines of the main scanning direction.

6. The image reading apparatus according to claim 1, wherein the processor detects the edge pixels in the sub-scanning direction at regular intervals in the main scanning direction in the input image.

7. The image reading apparatus according to claim 1, wherein the processor detects a medium width based on the end portion detected by the processor.

8. The image reading apparatus according to claim 1, wherein the processor detects a side edge of the medium based on the end portion detected by the processor.

9. The image reading apparatus according to claim 1, further comprising a conveyance roller to convey the medium, wherein
the processor imaging device images the medium conveyed by the conveyance roller.

10. The image reading apparatus according to claim 1, further comprising a motor to move the imaging device.

11. An image processing method, comprising:
imaging a medium by an imaging device;
detecting a plurality of edge pixels in a sub-scanning direction based on gradation values of a plurality of pixels of which positions in a main scanning direction are mutually the same and a distance between pixels in the sub-scanning direction is within a predetermined range in an input image acquired by imaging the medium by the imaging device;
detecting an end portion in the main scanning direction of a front end or a rear end of the medium based on a positional relationship between the detected plurality of edge pixels in the sub-scanning direction; and
outputting information relating to the detected end portion.

12. The image processing method according to claim 11, wherein the end portion is detected based on the number or a ratio of the edge pixels in the sub-scanning direction within a certain range in the main scanning direction.

13. The image processing method according to claim 11, wherein the end portion is detected based on the edge pixels in the sub-scanning direction continuously detected in the main scanning direction.

14. The image processing method according to claim 11, wherein the end portion is detected based on a distance in the sub-scanning direction between each of the plurality of edge pixels in the sub-scanning direction.

15. The image processing method according to claim 11, wherein the end portion is detected based on a frequency of the edge pixels in the sub-scanning direction for a plurality of lines of the main scanning direction.

16. A computer-readable, non-transitory medium storing a computer program, wherein the computer program causes an image reading apparatus including an imaging device to image a medium, to execute a process, the process comprising:
detecting a plurality of edge pixels in a sub-scanning direction based on gradation values of a plurality of pixels of which positions in a main scanning direction are mutually the same and a distance between pixels in the sub-scanning direction is within a predetermined range in an input image acquired by imaging the medium by the imaging device;
detecting an end portion in the main scanning direction of a front end or a rear end of the medium based on a positional relationship between the detected plurality of edge pixels in the sub-scanning direction; and
outputting information relating to the detected end portion.

17. The computer-readable, non-transitory medium according to claim 16, wherein the end portion is detected based on the number or a ratio of the edge pixels in the sub-scanning direction within a certain range in the main scanning direction.

18. The computer-readable, non-transitory medium according to claim 16, wherein the end portion is detected based on the edge pixels in the sub-scanning direction continuously detected in the main scanning direction.

19. The computer-readable, non-transitory medium according to claim 16, wherein the end portion is detected based on a distance in the sub-scanning direction between each of the plurality of edge pixels in the sub-scanning direction.

20. The computer-readable, non-transitory medium according to claim 16, wherein the end portion is detected based on a frequency of the edge pixels in the sub-scanning direction for a plurality of lines of the main scanning direction.
